(19) United States
(12) Patent Application Publication
(10) Pub. No.: US 2025/0007137 A1
(43) Pub. Date: Jan. 2, 2025

(54) MASKING FEATURES FOR BATTERY CELLS

(71) Applicant: Rivian IP Holdings, LLC, Irvine, CA (US)

(72) Inventors: Akshay Kishor MURKUTE, Irvine, CA (US); Andrew Richard CAMPBELL, Laguna Niguel, CA (US); Thomas BLOXHAM, San Francisco, CA (US); Kin-Seng WONG, Irvine, CA (US); Nick MARKER, Irvine, CA (US)

(21) Appl. No.: 18/525,689

(22) Filed: Nov. 30, 2023

Related U.S. Application Data
(60) Provisional application No. 63/511,609, filed on Jun. 30, 2023.

(51) Int. Cl. H01M 50/664; H01M 50/24; H01M 50/249; H01M 50/536

(52) U.S. Cl. CPC H01M 50/664; H01M 50/24; H01M 50/249; H01M 50/536; H01M 2220/20

(57) ABSTRACT

Aspects of the subject disclosure relate to various masking features for battery cells. Masking features for battery cells may include masks that are mounted to a cell cap of a battery cell, masking features extending from other electrical components to provide masking for the battery cells, and/or or a compressible internal material provided under or within the cell cap.

### CROSS REFERENCE TO RELATED APPLICATIONS

This application claims the benefit of priority to U.S. Provisional Patent Application No. 63/511,609, entitled, “Battery Subassembly”, filed on Jun. 30, 2023, the disclosure of which is hereby incorporated herein in its entirety.

### INTRODUCTION

Batteries are often used as a source of power, including as a source of power for electric vehicles that include wheels that are driven by an electric motor that receives power from the battery.

Aspects of the subject technology can help to improve the manufacturability and/or proliferation of electric vehicles, which can help to mitigate climate change by reducing greenhouse gas emissions.

### SUMMARY

The present disclosure generally relates to various aspects of mask features for battery cells. The mask features may be configured to prevent a potting material from flowing below the cell cap, which can prevent operation of a current interrupt device (CID) of the cell. The cell mask features can include a mask structure mounted on the cell cap, a mask structure formed as part of a current collector assembly (CCA), or a compressible internal material provided under or within the cell cap. In one or more implementations, aspects of the subject technology can help facilitate the function of a charge interrupt device and/or a current interrupt device of various designs in assemblies built from single cells for use as power supplies.

In accordance with one or more aspects of the disclosure, an apparatus is provided that includes a mask configured to be mounted to a cap of a battery cell. The mask may include at least one blocking structure configured to be mounted over an opening in the cap of the battery cell to prevent a liquid from flowing into the opening. The at least one blocking structure may include a plurality of blocking structures configured to be mounted over a plurality of corresponding openings in the cap of the battery cell.

The mask further may include a bridge structure, and the plurality of blocking structures may extend radially from the bridge structure. The plurality of blocking structures may extend radially inward from the bridge structure, and may be configured to tuck into the plurality of corresponding openings in the cap of the battery cell.

The bridge structure may define a central opening configured to be mounted over the cap of the battery cell. The mask may also include a plurality of peripheral openings. Each of the peripheral openings may be disposed between a pair of the plurality of blocking structures, and each of the plurality of peripheral openings may be configured to: allow a gas to flow therethrough between the opening in the cap of the battery cell and an environment external to the mask, and to prevent the liquid from flowing therethrough.

The liquid may include a potting material, and the mask may be mounted to the cap of the battery cell using a snap fit or a press fit. The mask may be formed from a flexible material. The flexible material may include a polymer or a rubber. In one or more implementations, the mask may be formed from a polymer or rubber gasket. The mask and the battery cell may be implemented in a vehicle.

In accordance with one or more aspects of the disclosure, an apparatus is provided that includes a frame; a plurality of tabs extending from the frame and configured to electrically couple to a plurality of respective battery cells, each having a cell cap with a cutout; and a plurality of blocking structures extending from the frame, each of the plurality of blocking structures configured to prevent a liquid from flowing into the cutout of one or more of the plurality of respective battery cells. The liquid may include a potting material that is configured, in a liquid state, to flow into a space between the plurality of respective battery cells, and to cure into a solid material in the space between the plurality of respective battery cells. The apparatus may also include a current collector assembly comprising the carrier structure, the plurality of tabs, and the plurality of blocking structures.

The apparatus may also include the plurality of respective battery cells. The plurality of tabs may be welded to the plurality of respective battery cells, and the potting material may be in contact with a first side of each of the plurality of blocking structures, the first side opposite a second side that faces the cutout of one or more of the plurality of respective battery cells. The apparatus may also include an open space, the open space being free of the potting material, between a current interrupt device and the cell cap of each of the plurality of respective battery cells.

In accordance with one or more aspects of the disclosure, a battery cell is provided that includes a cap with at least one opening; a current interrupt device; a cavity disposed between the cap and the current interrupt device; and a compliant material within the cavity between the cap and the current interrupt device. The compliant material may extend from the current interrupt device to the cap. The compliant material may be formed on an inner surface of the cap and extend toward the current interrupt device within the cavity. The compliant material may be separated by a gap from the current interrupt device. The compliant material may be compressible responsive to a pressure generated by a motion of the current interrupt device.

In accordance with one or more aspects of the disclosure, an apparatus is provided that includes a battery cell having a cap with at least one opening; and a mask structure mounted to the cap of the battery cell. The mask structure may include at least one blocking structure mounted over the at least one opening in the cap of the battery cell to prevent a liquid from flowing into the opening and to allow a gas to flow between the opening in the cap of the battery cell and an environment external to the mask structure. The at least one opening may include a vent for a current interrupt device (CID) of the apparatus.

In accordance with one or more aspects of the disclosure, a vehicle may be provided that includes a mask structure mounted to a cap of a battery cell. The mask structure may include at least one blocking structure mounted over at least one opening in the cap of the battery cell to prevent a liquid from flowing into the at least one opening and to allow a gas to flow between the at least one opening in the cap of the battery cell and an environment external to the mask structure.

In accordance with one or more aspects of the disclosure, a method may be provided, the method including obtaining a battery cell having a cap with at least one opening; obtaining a mask having at least one blocking structure; and mounting the mask to the cap of the battery cell such that the at least one blocking structure is mounted at least partially over the at least one opening.

In accordance with one or more aspects of the disclosure, a method may be provided, the method including providing a plurality of battery cells; welding a plurality of tabs extending from a frame of a current collector assembly to the plurality of battery cells; and blocking an opening in a cap of each of the battery cells with a plurality mask structures that extend from the frame.

In accordance with one or more aspects of the disclosure, a method may be provided that includes obtaining a battery cell having a cap with at least one opening; providing a compliant material in a first portion of a cavity formed in part by the cap and fluidly coupled to the opening; and providing a potting material onto the battery cell, a portion of the potting material flowing into a second portion of the cavity. The method may also include compressing, via operation of a current interrupt device of the battery cell, the compliant material.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle having a battery pack in accordance with one or more implementations.

FIG. 1C illustrates a schematic perspective view of a building having a battery pack in accordance with one or more implementations.

FIG. 2A illustrates a schematic perspective view of a battery pack in accordance with one or more implementations.

FIG. 2B illustrates schematic perspective views of various battery modules that may be included in a battery pack in accordance with one or more implementations.

FIG. 2C illustrates a cross-sectional end view of a battery cell in accordance with one or more implementations.

FIG. 2D illustrates a cross-sectional perspective view of a cylindrical battery cell in accordance with one or more implementations.

FIG. 2E illustrates a cross-sectional perspective view of a prismatic battery cell in accordance with one or more implementations.

FIG. 2F illustrates a cross-sectional perspective view of a pouch battery cell in accordance with one or more implementations.

FIG. 3 illustrates a perspective view of a battery module in accordance with one or more implementations.

FIG. 4 illustrates an exploded perspective view of the battery module of FIG. 3 in accordance with one or more implementations.

FIG. 5 illustrates a cross-sectional view of a portion of an example battery cell in accordance with one or more implementations.

FIG. 6 illustrates an top view of an example battery cell in accordance with one or more implementations.

FIG. 7 illustrates a top view of an example mask mounted to a battery cell in accordance with one or more implementations.

FIG. 8 illustrates a top view of another example mask mounted to a battery cell in accordance with one or more implementations.

FIG. 9 illustrates a top perspective view of the mask of FIG. 8 in accordance with one or more implementations.

FIG. 10 illustrates a perspective view of a battery cell with the mask of FIG. 8 in accordance with one or more implementations.

FIG. 11 illustrates a cross-sectional view of a battery cell with the mask of FIG. 8 in accordance with one or more implementations.

FIG. 12 illustrates a top view of a portion of a battery subassembly with a current collector assembly having tabs welded to terminals of battery cells in accordance with one or more implementations.

FIG. 13 illustrates a top view of a portion of a battery subassembly with a current collector assembly having tabs welded to terminals of battery cells and having masking structures extending therefrom in accordance with one or more implementations.

FIG. 14 illustrates a cross-sectional view of a portion of a battery cell with a compliant material disposed under a cell cap of the battery cell in accordance with one or more implementations.

FIG. 15 illustrates a cross-sectional view of a portion of a battery cell with a compliant material and a potting material disposed under a cell cap of the battery cell in accordance with one or more implementations.

FIG. 16 is a flow chart of illustrative operations that may be performed for providing a battery cell with a mask in accordance with one or more implementations.

FIG. 17 is a flow chart of illustrative operations that may be performed for providing masking for battery cells using a current collector assembly with a mask in accordance with one or more implementations.

FIG. 18 is a flow chart of illustrative operations that may be performed for providing protection for a current interrupt device of a battery cell in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the subject technology described herein relate to battery cells and masking features for the battery cells. Battery cells may be provided in a battery module or other battery subassembly. A battery module may be implemented in a battery pack that includes multiple battery modules. The battery cells and masking features may be implemented in an electric vehicle or other movable apparatus, and/or as a power source for a building or other stationary apparatus. Further details of various aspects of masking features for battery cells are described hereinafter.

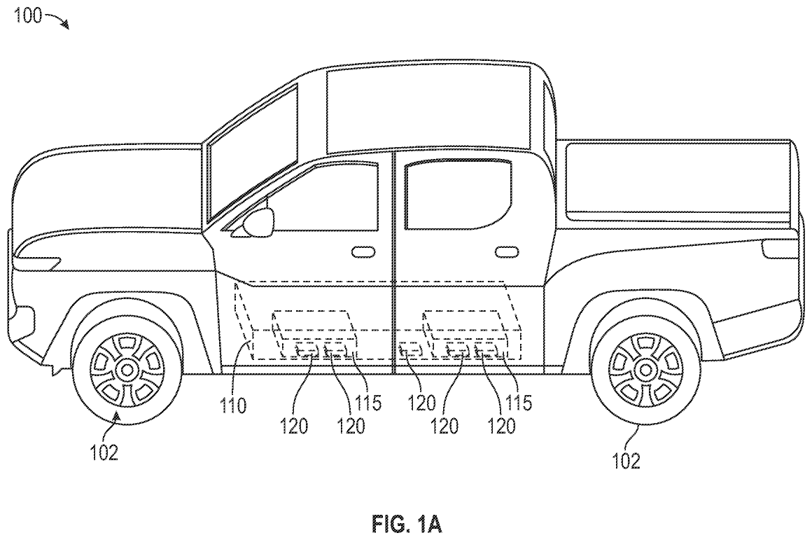

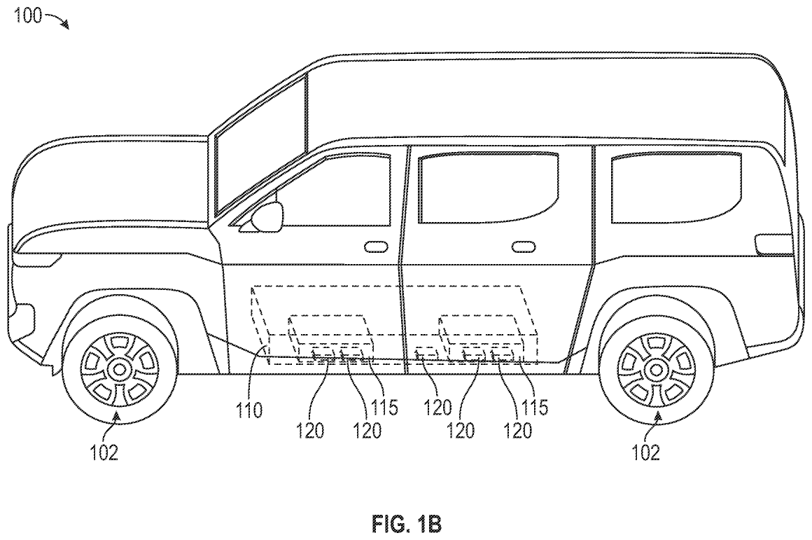

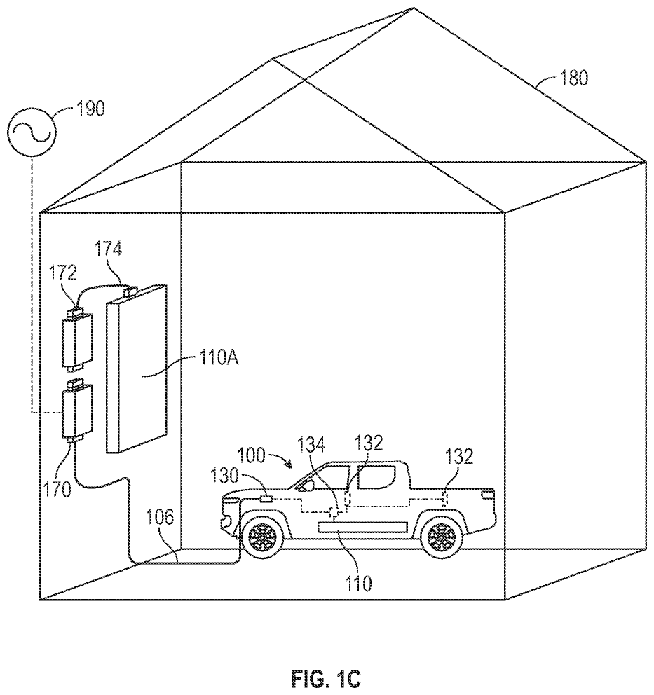

FIG. 1A is a diagram illustrating an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle using electric power from the battery pack 110. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid).

In the example of FIG. 1A, the vehicle 100 is implemented as a truck (e.g., a pickup truck) having a battery pack 110. As shown, the battery pack 110 may include one or more battery subassemblies, for example battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without any battery modules 115 and with the battery cells 120 mounted directly in the battery pack 110 (e.g., in a cell-to-pack configuration) and/or in other battery units that are installed in the battery pack 110. A vehicle battery pack can include multiple energy storage devices that can be arranged into such as battery modules or battery units. A battery subassembly, unit or module can include an assembly of cells that can be combined with other elements (e.g., structural frame, thermal management devices) that can protect the assembly of cells from heat, shock and/or vibrations.

For example, the battery cell 120 can be included a battery, a battery unit, a battery module and/or a battery pack to power components of the vehicle 100. For example, a battery cell housing of the battery cell 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle and/or the motor(s) that drive the wheels 102 of the vehicle). The power stage circuit can be provided as part of the battery pack 110 or separately from the battery pack 110 within the vehicle 100.

The example of FIG. 1A in which the vehicle 100 is implemented as a pickup truck having a truck bed at the rear portion thereof is merely illustrative. For example, FIG. 1B illustrates another implementation in which the vehicle 100 including the battery pack 110 is implemented as a sport utility vehicle (SUV), such as an electric sport utility vehicle. In the example of FIG. 1B, the vehicle 100 including the battery pack 110 may include a cargo storage area that is enclosed within the vehicle 100 (e.g., behind a row of seats within a cabin of the vehicle). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, a battery pack such as the battery pack 110, a battery module 115, a battery cell 120, and/or any other battery unit as described herein may also, or alternatively, be implemented as an electrical power supply and/or energy storage system in a building, such as a residential home or commercial building. For example, FIG. 1C illustrates an example in which a battery pack 110 is implemented in a building 180. For example, the building 180 may be a residential building, a commercial building, or any other building. As shown, in one or more implementations, a battery pack 110 may be mounted to a wall of the building 180.

As shown, the battery 110A that is installed in the building 180 may be couplable to the battery pack 110 in the vehicle 100, such as via: a cable/connector 106 that can be connected to the charging port 130 of the vehicle 100, electric vehicle supply equipment 170 (EVSE), a power stage circuit 172, and/or a cable/connector 174. For example, the cable/connector 106 may be coupled to the EVSE 170, which may be coupled to the battery 110A via the power stage circuit 172, and/or may be coupled to an external power source 190. In this way, either the external power source 190 or the battery 110A that is installed in the building 180 may be used as an external power source to charge the battery pack 110 in the vehicle 100 in some use cases. In some examples, the battery 110A that is installed in the building 180 may also, or alternatively, be coupled (e.g., via a cable/connector 174, the power stage circuit 172, and the EVSE 170) to the external power source 190. For example, the external power source 190 may be a solar power source, a wind power source, and/or an electrical grid of a city, town, or other geographic region (e.g., electrical grid that is powered by a remote power plant). During, for example, times when the battery pack 110 in the vehicle 100 is not coupled to the battery 110A that is installed in the building 180, the battery 110A that is installed in the building 180 can be coupled (e.g., using the power stage circuit 172 for the building 180) to the external power source 190 to charge up and store electrical energy. In some use cases, this stored electrical energy in the battery 110A that is installed in the building 180 can later be used to charge the battery pack 110 in the vehicle 100 (e.g., during times when solar power or wind power is not available, in the case of a regional or local power outage for the building 180, and/or during a period of high rates for access to the electrical grid).

In one or more implementations, the power stage circuit 172 may electrically couple the battery 110A that is installed in the building 180 to an electrical system of the building 180. For example, the power stage circuit 172 may convert DC power from the battery 110A into AC power for one or more loads in the building 180. For example, the battery 110A that is installed in the building 180 may be used to power one or more lights, lamps, appliances, fans, heaters, air conditioners, and/or any other electrical components or electrical loads in the building 180 (e.g., via one or more electrical outlets that are coupled to the battery 110A that is installed in the building 180). For example, the power stage circuit 172 may include control circuitry that is operable to switchably couple the battery 110A between the external power source 190 and one or more electrical outlets and/or other electrical loads in the electrical system of the building 180. In one or more implementations, the vehicle 100 may include a power stage circuit (not shown in FIG. 1C) that can be used to convert power received from the electric vehicle supply equipment 170 to DC power that is used to power/charge the battery pack 110 of the vehicle 100, and/or to convert DC power from the battery pack 110 into AC power for one or more electrical systems, components, and/or loads of the vehicle 100.

In one or more use cases, the battery 110A that is installed in the building 180 may be used as a source of electrical power for the building 180, such as during times when solar power or wind power is not available, in the case of a regional or local power outage for the building 180, and/or during a period of high rates for access to the electrical grid (as examples). In one or more other use cases, the battery pack 110 that is installed in the vehicle may be used to charge the battery 110A that is installed in the building 180 and/or to power the electrical system of the building 180 (e.g., in a use case in which the battery 110A that is installed in the building 180 is low on or out of stored energy and in which solar power or wind power is not available, a regional or local power outage occurs for the building 180, and/or a period of high rates for access to the electrical grid occurs (as examples)).

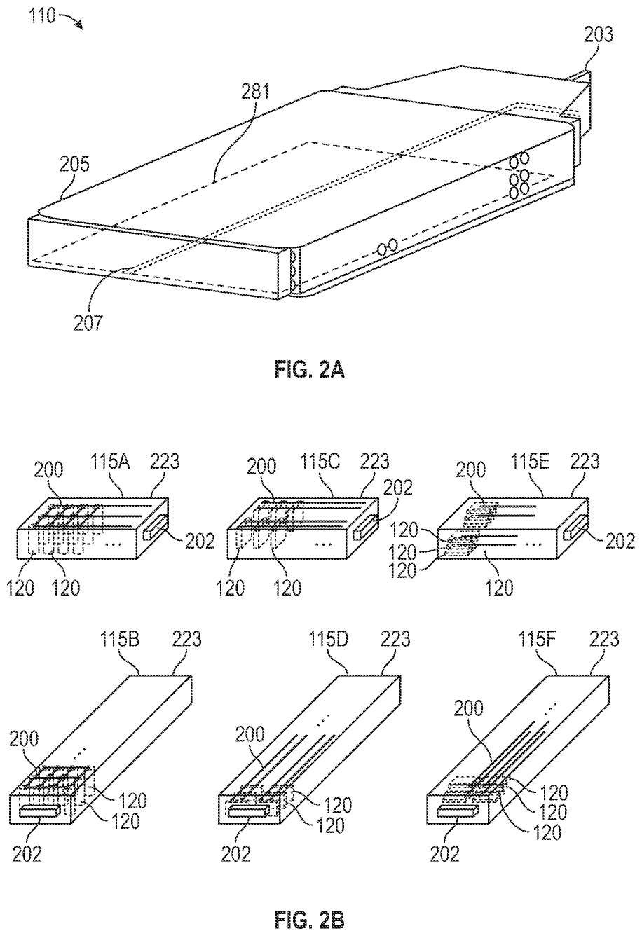

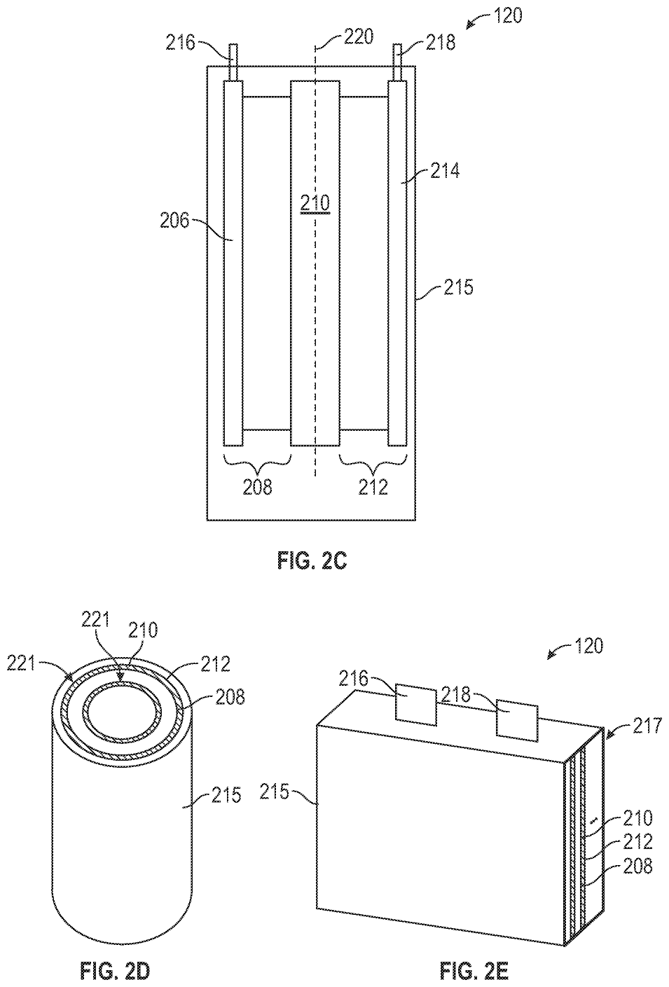

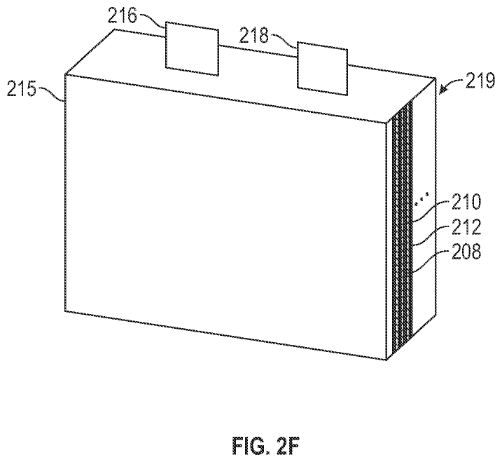

FIG. 2A depicts an example battery pack 110. Battery pack 110 may include multiple battery cells 120 (e.g., directly installed within the battery pack 110, or within batteries, battery units, and/or battery modules 115 as described herein) and/or battery modules 115, and one or more conductive coupling elements for coupling a voltage generated by the battery cells 120 to a power-consuming component, such as the vehicle 100 and/or an electrical system of a building 180. For example, the conductive coupling elements may include internal connectors and/or contactors that couple together multiple battery cells 120, battery units, batteries, and/or multiple battery modules 115 within the battery pack frame 205 to generate a desired output voltage for the battery pack 110. The battery pack 110 may also include one or more external connection ports, such as an electrical contact 203 (e.g., a high voltage terminal). For example, an electrical cable (e.g., cable/connector 106) may be connected between the electrical contact 203 and an electrical system of the vehicle 100 or the building 180, to provide electrical power to the vehicle 100 or the building 180.

As shown, the battery pack 110 may include a battery pack frame 205 (e.g., a battery pack housing or pack frame). For example, the battery pack frame 205 may house or enclose one or more battery modules 115 and/or one or more battery cells 120, and/or other battery pack components. In one or more implementations, the battery pack frame 205 may include or form a shielding structure on an outer surface thereof (e.g., a bottom thereof and/or underneath one or more battery module 115, battery units, batteries, and/or battery cells 120) to protect the battery module 115, battery units, batteries, and/or battery cells 120 from external conditions (e.g., if the battery pack 110 is installed in a vehicle 100 and the vehicle 100 is driven over rough terrain, such as off-road terrain, trenches, rocks, rivers, streams, etc.).

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules 115, battery units, batteries, and/or battery cells 120 within the battery pack frame 205, such as by distributing fluid through the battery pack 110.

For example, the thermal control structures 207 may form a part of a thermal/temperature control or heat exchange system that includes one or more thermal components 281 such as plates or bladders that are disposed in thermal contact with one or more battery modules 115 and/or battery cells 120 disposed within the battery pack frame 205. For example, a thermal component 281 may be positioned in contact with one or more battery modules 115, battery units, batteries, and/or battery cells 120 within the battery pack frame 205. In one or more implementations, the battery pack 110 may include one or multiple thermal control structures 207 and/or other thermal components for each of several top and bottom battery module pairs. As shown, the battery pack 110 may include an electrical contact 203 (e.g., a high voltage connector) by which an external load (e.g., the vehicle 100 or an electrical system of the building 180) may be electrically coupled to the battery modules and/or battery cells in the battery pack 110.

FIG. 2B depicts various examples of battery modules 115 that may be disposed in the battery pack 110 (e.g., within the battery pack frame 205 of FIG. 2A). In the example of FIG. 2B, a battery module 115A is shown that includes a battery module housing 223 having a rectangular cuboid shape with a length that is substantially similar to its width. In this example, the battery module 115A includes multiple battery cells 120 implemented as cylindrical battery cells. In this example, the battery module 115A includes rows and columns of cylindrical battery cells that are coupled together by an interconnect structure 200 (e.g., a current connector assembly or CCA). For example, the interconnect structure 200 may couple together the positive terminals of the battery cells 120, and/or couple together the negative battery terminals of the battery cells 120. As shown, the battery module 115A may include a charge collector or bus bar 202. For example, the bus bar 202 may be electrically coupled to the interconnect structure 200 to collect the charge generated by the battery cells 120 to provide a high voltage output from the battery module 115A.

FIG. 2B also shows a battery module 115B having an elongate shape, in which the length of the battery module housing 223 (e.g., extending along a direction from a front end of the battery pack 110 to a rear end of the battery pack 110 when the battery module 115B is installed in the battery pack 110) is substantially greater than a width (e.g., in a transverse direction to the direction from the front end of the battery pack 110 to the rear end of the battery pack 110 when the battery module 115B is installed in the battery pack 110) of the battery module housing 223. For example, one or more battery modules 115B may span the entire front-to-back length of a battery pack within the battery pack frame 205. As shown, the battery module 115B may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115B.

In the implementations of battery module 115A and battery module 115B, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115C having a battery module housing 223 having a rectangular cuboid shape with a length that is substantially similar to its width and including multiple battery cells 120 implemented as prismatic battery cells. In this example, the battery module 115C includes rows and columns of prismatic battery cells that are coupled together by an interconnect structure 200 (e.g., a current collector assembly or CCA). For example, the interconnect structure 200 may couple together the positive terminals of the battery cells 120 and/or couple together the negative battery terminals of the battery cells 120. As shown, the battery module 115C may include a charge collector or bus bar 202. For example, the bus bar 202 may be electrically coupled to the interconnect structure 200 to collect the charge generated by the battery cells 120 to provide a high voltage output from the battery module 115C.

FIG. 2B also shows a battery module 115D including prismatic battery cells and having an elongate shape, in which the length of the battery module housing 223 (e.g., extending along a direction from a front end of the battery pack 110 to a rear end of the battery pack 110 when the battery module 115D is installed in the battery pack 110) is substantially greater than a width (e.g., in a transverse direction to the direction from the front end of the battery pack 110 to the rear end of the battery pack 110 when the battery module 115D is installed in the battery pack 110) of the battery module housing 223. For example, one or more battery modules 115D having prismatic battery cells may span the entire front-to-back length of a battery pack within the battery pack frame 205. As shown, the battery module 115D may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115D.

As another example, FIG. 2B also shows a battery module 115E having a battery module housing 223 having a rectangular cuboid shape with a length that is substantially similar to its width and including multiple battery cells 120 implemented as pouch battery cells. In this example, the battery module 115C includes rows and columns of pouch battery cells that are coupled together by an interconnect structure 200 (e.g., a current collector assembly or CCA). For example, the interconnect structure 200 may couple together the positive terminals of the battery cells 120 and couple together the negative battery terminals of the battery cells 120. As shown, the battery module 115E may include a charge collector or bus bar 202. For example, the bus bar 202 may be electrically coupled to the interconnect structure 200 to collect the charge generated by the battery cells 120 to provide a high voltage output from the battery module 115E.

FIG. 2B also shows a battery module 115F including pouch battery cells and having an elongate shape in which the length of the battery module housing 223 (e.g., extending along a direction from a front end of the battery pack 110 to a rear end of the battery pack 110 when the battery module 115E is installed in the battery pack 110) is substantially greater than a width (e.g., in a transverse direction to the direction from the front end of the battery pack 110 to the rear end of the battery pack 110 when the battery module 115E is installed in the battery pack 110) of the battery module housing 223. For example, one or more battery modules 115E having pouch battery cells may span the entire front-to-back length of a battery pack within the battery pack frame 205. As shown, the battery module 115E may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115E.

In various implementations, a battery pack 110 may be provided with one or more of any of the battery modules 115A, 115B, 115C, 115D, 115E, and 115F. In one or more other implementations, a battery pack 110 may be provided without battery modules 115 (e.g., in a cell-to-pack implementation).

In one or more implementations, multiple battery modules 115 in any of the implementations of FIG. 2B may be coupled (e.g., in series) to a current collector of the battery pack 110. In one or more implementations, the current collector may be coupled, via a high voltage harness, to one or more external connectors (e.g., electrical contact 203) on the battery pack 110. In one or more implementations, the battery pack 110 may be provided without any battery modules 115. For example, the battery pack 110 may have a cell-to-pack configuration in which battery cells 120 are arranged directly into the battery pack 110 without assembly into a battery module 115 (e.g., without including a separate battery module housing 223). For example, the battery pack 110 (e.g., the battery pack frame 205) may include or define a plurality of structures for positioning of the battery cells 120 directly within the battery pack frame 205.

FIG. 2C illustrates a cross-sectional end view of a portion of a battery cell 120. As shown in FIG. 2C, a battery cell 120 may include an anode 208, an electrolyte 210, and a cathode 212. As shown, the anode 208 may include or be electrically coupled to a first current collector 206 (e.g., a metal layer such as a layer of copper foil or other metal foil). As shown, the cathode 212 may include or be electrically coupled to a second current collector 214 (e.g., a metal layer such as a layer of aluminum foil or other metal foil). As shown, the battery cell 120 may include a first terminal 216 (e.g., a negative terminal) coupled to the anode 208 (e.g., via the first current collector 206 and/or one or more tabs extending therefrom) and a second terminal 218 (e.g., a positive terminal) coupled to the cathode (e.g., via the second current collector 214 and/or one or more tabs extending therefrom). In various implementations, the electrolyte 210 may be a liquid electrolyte layer or a solid electrolyte layer. In one or more implementations (e.g., implementations in which the electrolyte 210 is a liquid electrolyte layer), the battery cell 120 may include a separator layer 220 that separates the anode 208 from the cathode 212. In one or more implementations in which the electrolyte 210 is a solid electrolyte layer, the solid electrolyte layer may act as both separator layer and an electrolyte layer.

In one or more implementations, the battery cell 120 may be implemented as a lithium ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. As shown, the battery cell 120 may include a separator layer 220 that separates the anode 208 from the cathode 212. In an implementation in which the battery cell 120 is implemented as a lithium-ion battery cell, the electrolyte 210 may include a lithium salt in an organic solvent. The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cells 120 are implemented as lithium-ion battery cells, some or all of the battery cells 120 in a battery module 115, battery pack 110, or other battery or battery unit may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials.

In various implementations, the anode 208, the electrolyte 210, and the cathode 212 of FIG. 2C can be packaged into a battery cell housing having any of various shapes, and/or sizes, and/or formed from any of various suitable materials. For example, battery cells 120 can have a cylindrical, rectangular, square, cubic, flat, pouch, elongated, or prismatic outer shape. As depicted in FIG. 2D, for example, a battery cell such as the battery cell 120 may be implemented as a cylindrical cell. In the example of FIG. 2D, the battery cell 120 includes a cell housing 215 having a cylindrical outer shape. For example, the anode 208, the electrolyte 210, and the cathode 212 may be rolled into one or more substantially cylindrical windings 221. As shown, one or more windings 221 of the anode 208, the electrolyte 210, and the cathode 212 (e.g., and/or one or more separator layers such as separator layer 220) may be disposed within the cell housing 215. For example, a separator layer may be disposed between adjacent ones of the windings 221. However, the cylindrical cell implementation of FIG. 2D is merely illustrative, and other implementations of the battery cells 120 are contemplated.

For example, FIG. 2E illustrates an example in which the battery cell 120 is implemented as a prismatic cell. As shown in FIG. 2E, the battery cell 120 may have a cell housing 215 having a right prismatic outer shape. As shown, one or more layers of the anode 208, the cathode 212, and the electrolyte 210 disposed therebetween may be disposed (e.g., with separator materials between the layers) within the cell housing 215 having the right prismatic shape. As examples, multiple layer of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 215 having the right prismatic shape. In the implementation of FIG. 2E, the cell housing 215 has a relatively thick cross-sectional width 217 and is formed from a rigid material. For example, the cell housing 215 in the implementation of FIG. 2E may be formed from a welded, stamped, deep drawn, and/or impact extruded metal sheet, such as a welded, stamped, deep drawn, and/or impact extruded aluminum sheet. For example, the cross-sectional width 217 of the cell housing 215 of FIG. 2E may be as much as, or more than 1 millimeter (mm) to provide a rigid housing for the prismatic battery cell. In one or more implementations, the first terminal 216 and the second terminal 218 in the prismatic cell implementation of FIG. 2E may be formed from a feedthrough conductor that is insulated from the cell housing 215 (e.g., a glass to metal feedthrough) as the conductor passes through to cell housing 215 to expose the first terminal 216 and the second terminal 218 outside the cell housing 215 (e.g., for contact with an interconnect structure 200 of FIG. 2B). However, this implementation of FIG. 2E is also illustrative and yet other implementations of the battery cell 120 are contemplated.

For example, FIG. 2F illustrates an example in which the battery cell 120 is implemented as a pouch cell. As shown in FIG. 2F, one or more layers of the anode 208, the cathode 212, and the electrolyte 210 disposed therebetween may be disposed (e.g., with separator materials between the layers) within the cell housing 215 that forms a flexible or malleable pouch housing. In the implementation of FIG. 2F, the cell housing 215 has a relatively thin cross-sectional width 219. For example, the cell housing 215 in the implementation of FIG. 2F may be formed from a flexible or malleable material (e.g., a foil, such as a metal foil, or film, such as an aluminum-coated plastic film). For example, the cross-sectional width 219 of the cell housing 215 of FIG. 2F may be as low as, or less than 0.1 mm, 0.05 mm, 0.02 mm, or 0.01 mm to provide flexible or malleable housing for the pouch battery cell. In one or more implementations, the first terminal 216 and the second terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 215 in these implementations. In the examples of FIGS. 2C, 2E, and 2F, the first terminal 216 and the second terminal 218 are formed on the same side (e.g., a top side) of the battery cell 120. However, this is merely illustrative and, in other implementations, the first terminal 216 and the second terminal 218 may formed on two different sides (e.g., opposing sides, such as a top side and a bottom side) of the battery cell 120. The first terminal 216 and the second terminal 218 may be formed on a same side or difference sides of the cylindrical cell of FIG. 2D in various implementations.

In one or more implementations, a battery module 115, a battery pack 110, a battery unit, or any other battery may include some battery cells 120 that are implemented as solid-state battery cells and other battery cells 120 that are implemented with liquid electrolytes for lithium-ion or other battery cells having liquid electrolytes. One or more of the battery cells 120 may be included a battery module 115 or a battery pack 110, such as to provide an electrical power supply for components of the vehicle 100, the building 180, or any other electrically powered component or device. The cell housing 215 of the battery cell 120 can be disposed in the battery module 115, the battery pack 110, or installed in any of the vehicle 100, the building 180, or any other electrically powered component or device.

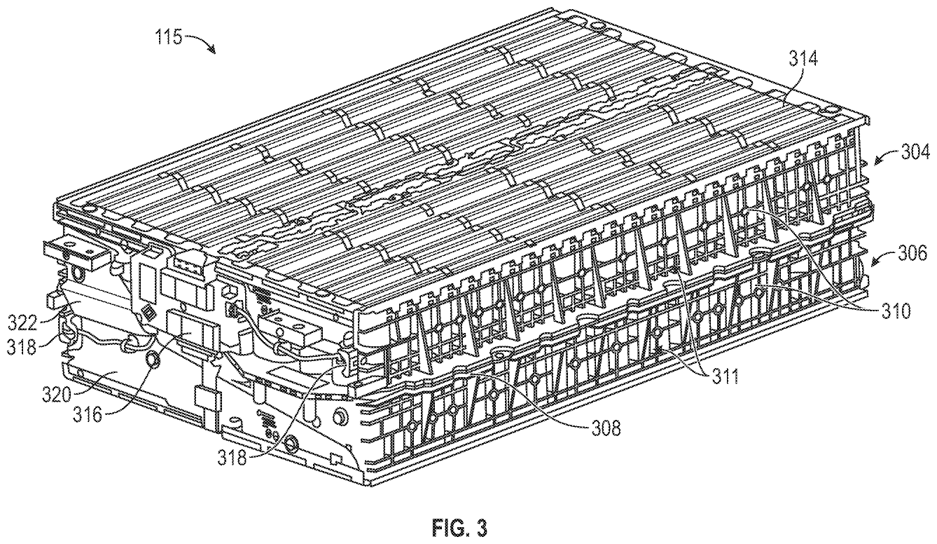

FIG. 3 illustrates a perspective view of a battery module in accordance with one or more implementations. In the example of FIG. 3, the battery module 115 includes a top submodule 304 and a bottom submodule 306. As shown, each of the top submodule 304 and the bottom submodule 306 may include a cell carrier 310. In one or more implementations, each cell carrier 310 may be a monolithic unitary body (e.g., a molded body formed from plastic and/or other materials), and may include structural features 311 along the sidewalls thereof. These structural features 311 may reinforce the strength of the sidewalls of the carrier, and thereby reduce or eliminate the need for additional structural reinforcing components for the battery module 115, such as shear walls attached to the cell carriers 310. Also visible in FIG. 3 is a cold plate 308 that is disposed between the top submodule 304 and the bottom submodule 306. The cold plate 308 may be in thermal contact with battery cells (not visible in FIG. 3) in the top submodule 304 and battery cells (not visible in FIG. 3) in the bottom submodule 306, to provide thermal control for both the top submodule 304 and the bottom submodule 306.

FIG. 3 also illustrates a cover 314 that may be disposed on a top and/or a bottom of the battery module 115. FIG. 3 also illustrates a balancing voltage and temperature (BVT) module 316 to which multiple thermistor assemblies 318 are communicatively coupled. The BVT can be a modular assembly of various electrical components to monitor or control components of the battery subassembly. For example, the BVT can include a circuit board that is attached to the housing of the BVT. The BVT can have various connectors to couple with, for example, a thermistor that can measure a temperature of the battery subassembly, battery module and/or a battery cell thereof, a voltage sensor or balancer that can sense or control voltage that flows through the battery subassembly, battery module and/or a battery cell thereof, or a communication device that can receive, transmit, or analyze data associated with the battery subassembly, battery module and/or a battery cell thereof. Also shown in FIG. 3 are a busbar 320 (e.g., a positive busbar) that is electrically coupled to first terminals (e.g., the positive terminals) of the battery cells of the top submodule 304 and the bottom submodule 306, and a busbar 322 (e.g., a negative busbar) that is electrically coupled to second terminals (e.g., the negative terminals) of the battery cells of the top submodule 304 and the bottom submodule 306.

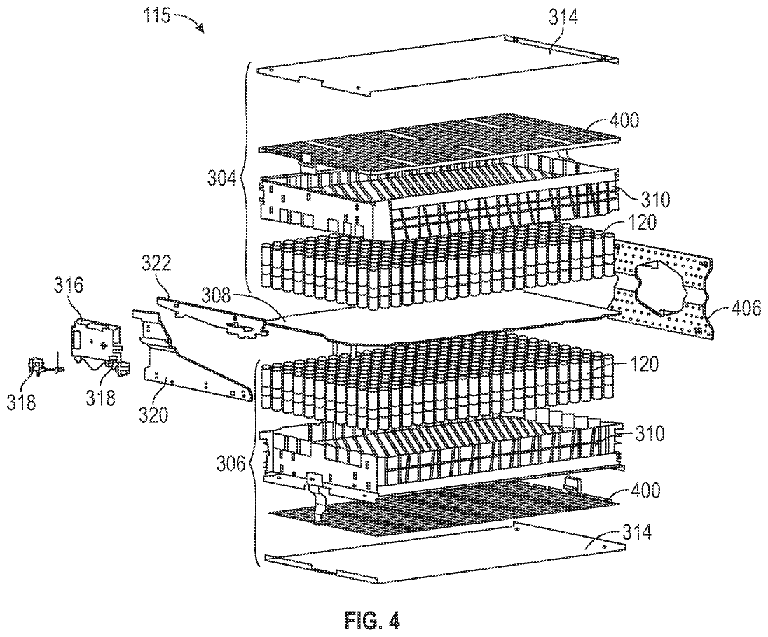

FIG. 4 illustrates an exploded perspective view of the battery module 115 of FIG. 3, in which the battery cells 120 of the top submodule 304 and the battery cells 120 of the bottom submodule 306 can be seen. In one or more examples described herein, the battery module 115, a subset of the components of the battery module 115 (e.g., the top submodule 304, the bottom submodule 306, and/or another subset of the components of the battery module) shown in FIG. 3 and/or FIG. 4, or any other grouping of battery cells (e.g., including a battery pack that includes multiple battery modules and/or other battery subassemblies) may be referred to as a battery subassembly.

In the example of FIG. 4, two current collector assemblies (CCAs) 400 are also visible which, when the battery module 115 is assembled, connect the terminals of the battery cells 120 of the top submodule 304 and the bottom submodule 306 to the busbar 320 and the busbar 322. As shown in FIG. 4, a series busbar 406 may also be provided (e.g., on an opposing end of the cell carriers 310 from the end of the cell carriers at which the busbar 320 and the busbar 322 are mounted). For example, the series busbar 406 may electrically coupled the battery cells 120 of the top submodule 304 to the battery cells 120 of the bottom submodule 306. As shown, a cover 314 may be provided for the top submodule 304 and a cover 314 may be provided for the bottom submodule 306.

As discussed in further detail hereinafter, the battery cells 120 of the top submodule 304 may be inserted into a crate structure formed by the cell carrier 310 of the top submodule 304, and the battery cells 120 of the bottom submodule 306 may be inserted into a crate structure formed by the cell carrier 310 of the bottom submodule 306. As shown in FIGS. 3 and 4, the orientation of the cell carrier 310 and the battery cells 120 of the top submodule 304 may be substantially opposite (e.g., upside down with respect) to the orientation of the cell carrier 310 and the battery cells 120 of the bottom submodule 306. In this way, the single cold plate 308 can be in thermal contact with the same ends (e.g., bottom ends) of the battery cells 120 of both the top and bottom submodules, and provide substantially symmetric thermal contact with the top and bottom submodules.

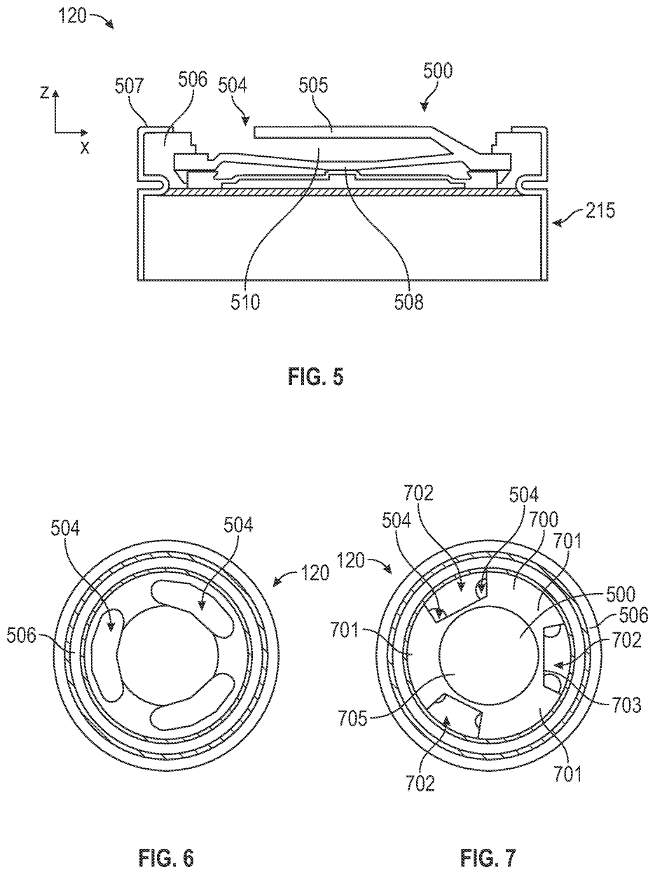

FIG. 5 illustrates a cross-sectional view of a portion of an example battery cell in accordance with one or more implementations. In the example of FIG. 5, the battery cell 120 includes a terminal structure 500. For example, the terminal structure 500 may include a terminal contact 505 that is electrically coupled to one or more electrodes (e.g., positive electrodes, such as cathode 212 of FIG. 2C) within the cell housing 215. As shown, the terminal structure 500 may be formed over a corresponding current interrupt device (CID) 508 for the battery cell 120. For example, the terminal contact 505 may be coupled to the electrode(s) within the cell housing 215 via the CID 508. The CID 508 may be formed as a part of the terminal structure 500 or may be a separate component from the terminal structure 500. In one or more implementations, the terminal structure 500 may form an enclosure member or a cap for the battery cell that, together with the cell housing 215 (e.g., a can), sealingly encloses the electrodes and the electrolyte of the battery cell. In one or more implementations, a peripheral rim 507 of the battery cell 120 may form another terminal contact (e.g., a negative terminal) that may be electrically coupled to one or more other electrodes (e.g., negative electrodes, such as anode 208) within the cell housing 215. The peripheral rim 507 may be electrically insulated from the terminal contact 505, and may be formed as a portion of the terminal structure 500 or may be a separate structure that is attached to the cell housing 215.

As shown, the terminal structure 500 may include one or more openings 504. For example, the openings 504 may be cutouts in the terminal structure 500 (e.g., cutouts in a cap of the battery cell 120). For example, the openings 504 may be arranged to allow a gas to flow out of the battery cell via the CID 508 when the CID 508 is triggered. For example, responsive to a pressure from within the battery cell, the CID 508 may be pressed upward (e.g., in the “y” direction of FIG. 5) into a cavity 510 between the CID 508 and the terminal structure 500, to disengage the terminal structure 500 from the electrodes to break the electrical circuit of the battery cell 120. In one or more implementations, the CID 508, when pressed upward into the cavity 510, may also mechanically break or otherwise open a venting pathway that allows a gas from within the battery cell 120 to be vented to, and through, the openings 504 in some situations (e.g., in the presence of an increase in pressure within the battery cell housing).

FIG. 6 illustrates a top view of the battery cell 120 of FIG. 5, showing a view of the openings 504. In the example of FIGS. 5 and 6, a gasket 506 is also shown. In one or more implementations, the gasket may be provided with a color (e.g., black, yellow, or orange) that is configured to be recognized by locating equipment of assembly equipment for the battery module 115. In this way, the gasket 506 can perform a gasket function and a reference index function for the battery cells.

In the example of FIG. 6, it can be seen that the openings 504 are open from the top of the battery cell 120. The battery module 115, or another battery subassembly in which the battery cells 120 are disposed, may be provided with a potting material that substantially fills the spaces between the battery cells 120 (e.g., to provide structural support and/or thermal coupling to the battery cells). During the assembly process for a battery module 115, the potting material may be disposed or poured onto the battery module in a liquid form. Some of the potting material may inadvertently flow into cavity 510 via the openings 504. Potting material in the cavity 510 can prevent the CID 508 from moving upward into the cavity 510, which can affect the ability of the CID to function to disconnect the battery circuit within the battery cell and to vent gasses from the battery cells.

FIG. 7 illustrates how, in one or more implementations, a mask 700 may be provided for a battery cell 120. For example, the mask 700 may be configured to be mounted to the terminal structure 500 of the battery cell 120. As shown, the mask 700 may include at least one blocking structure 701. The blocking structure 701 may be configured to be mounted over an opening 504 in the terminal structure 500 of the battery cell 120. For example, the mask may prevent a liquid (e.g., a potting material) from flowing into the opening 504, and to allow a gas to flow between the opening 504 in the terminal structure 500 of the battery cell 120 and an environment external to the mask 700.

For example, as shown in FIG. 7, the mask 700 may include multiple blocking structures 701, configured to be mounted over multiple corresponding openings 504 in the terminal structure 500 of the battery cell 120. As shown, the mask 700 may also include a bridge structure 703. As shown, the blocking structures 701 may extend radially outward from the bridge structure 703. The bridge structure 703 may define a central opening 705 configured to be mounted over the terminal structure 500 of the battery cell 120 (e.g., over a central portion of the terminal structure 500 that forms a positive terminal for the battery cell). For example, the bridge structure 703 may extend around the periphery of the central opening 705 and interconnect the blocking structures 701. In one or more implementations, the bridge structure 703 may be adhesively attached to the terminal structure 500 to hold the mask in place on the cap of the battery cell 120. In one or more implementations, the bridge structure 703 may attach to the terminal structure 500 via a snap fit or a press fit to hold the mask in place on the cap of the battery cell 120.

As shown in FIG. 7, the mask 700 may also include one or more peripheral openings 702. For example, each of the peripheral openings 702 may be disposed between a pair blocking structures 701. In one or more implementations, each of the peripheral openings 702 may be configured (e.g., sized, shaped, and/or positioned) to allow gas to flow therethrough (e.g., to allow air to flow into the openings 504 and/or gas from the battery cell to pass out through the openings 504 and the peripheral openings 702) and to prevent the liquid (e.g., potting material) from flowing therethrough (e.g., into the openings 504). For example, each of the peripheral openings may extend over a portion of an opening 504 in the cap of the battery cell. For example, the one or more openings 504 and/or one or more peripheral openings 702 may form a vent for a current interrupt device (CID) (508) of the battery cell 120.

In one or more implementations, the mask 700 may be formed from a flexible material. As examples, the flexible material may include a polymer (e.g., polyethylene terephthalate (PET)) or a rubber. As discussed herein, in one or more implementations, the mask 700 and the battery cell 120 (e.g., to which the mask 700 is mounted) may be implemented in a vehicle (e.g., vehicle 100, such as in a battery module 115 of a battery pack 110 within an electric vehicle). As discussed herein, in one or more implementations, the mask 700 and the battery cell 120 (e.g., to which the mask 700 is mounted) may be implemented in a building (e.g., building 180, such as in a battery module 115 of a battery pack 110 within a building).

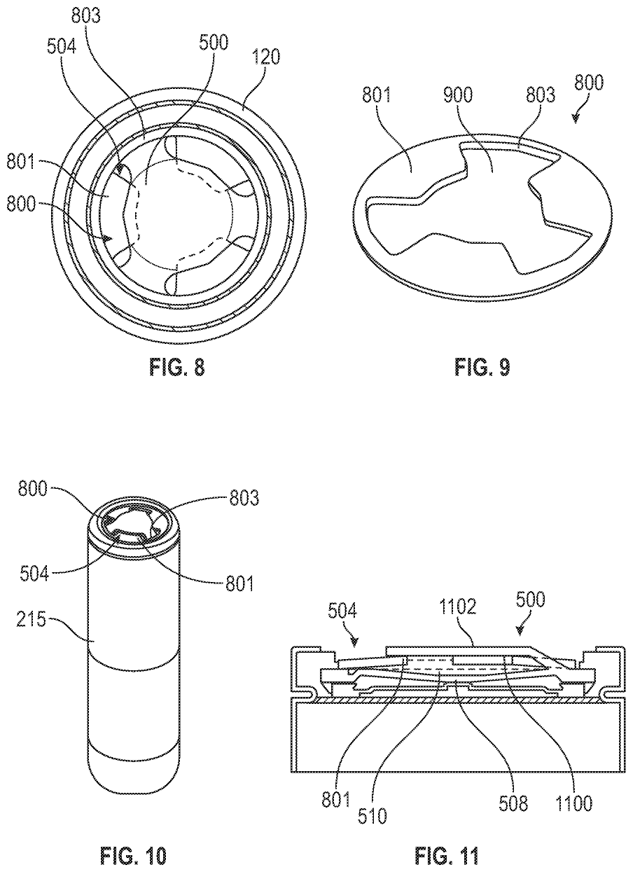

FIG. 8 illustrates a top view of the battery cell 120 with another implementation of a mask mounted thereon. In the example of FIG. 8, a mask 800 includes a bridge structure 803 at the outer periphery of the mask 800, and blocking structures 801 that extend radially inward from the bridge structure 803. In this example, the blocking structures 801 may each be configured to tuck into a corresponding one of the openings 504 in the terminal structure 500 of the battery cell 120. In this way, the mask 800 may be mechanically attached to the terminal structure 500 of the battery cell 120 via the tucking of the blocking structure 801 into the openings 504. Once tucked into the openings 504, the blocking structures 801 may block a liquid, such as potting material, from flowing through the openings 504 into the cavity 510.

As shown in FIG. 8, each of the blocking structures 801 may have a width that is less than the width of the openings 504 in the cap of the battery cell, so that, in addition to blocking liquid (e.g., potting material) from flowing through the openings 504 and into the cavity 510, the blocking structures 801 can be provided without blocking the venting paths created by the openings 504. FIG. 9 illustrates a top perspective view of the mask 800. As shown in FIG. 9, the mask 800 may include gaps 900 between each of the blocking structure 801. The gaps 900 may be sized and positioned such that, when the mask 800 is mounted on the terminal structure 500, the gaps 900 at least partially overlap two of the openings 504. FIG. 10 illustrates a perspective view of a battery cell 120 having the mask 800 mounted thereon, with the blocking structures 801 tucked into the openings 504 as described herein. FIG. 11 illustrates a cross-sectional view of the battery cell 120 of FIG. 10, in which one of the blocking structures 801 can be seen tucked into a corresponding opening 504. As shown, an end portion of the blocking structure 801 may contact an interior surface 1100 (e.g., an underside) of the terminal structure 500, which may help to hold the tucked blocking structure within the opening 504. As shown, the interior surface 1100 may be opposite an exterior surface 1102 (e.g., a terminal contact surface) of the terminal structure 500. Providing a mask 800 with blocking structures 801 that tuck into the openings 504 may also simplify manufacturing and/or assembly of battery cells and/or battery subassemblies (e.g., battery modules 115) including the battery cells, by providing blocking structures that automatically align the mask 800 with the cap of the battery cell as part of the tucking process.

In the examples of FIGS. 6-7 and 8-11, a mask (e.g., mask 700 or mask 800) is mounted directly to each of the battery cells 120. In one or more other implementations, blocking structures for preventing a liquid, such as a potting material, from flowing into the openings 504 of one or more battery cells 120 may be provided on a separate component from the battery cells 120. For example, the blocking structures may be provided on an electrical component, such as the current collector assembly (CCA) 400 of the battery module 115.

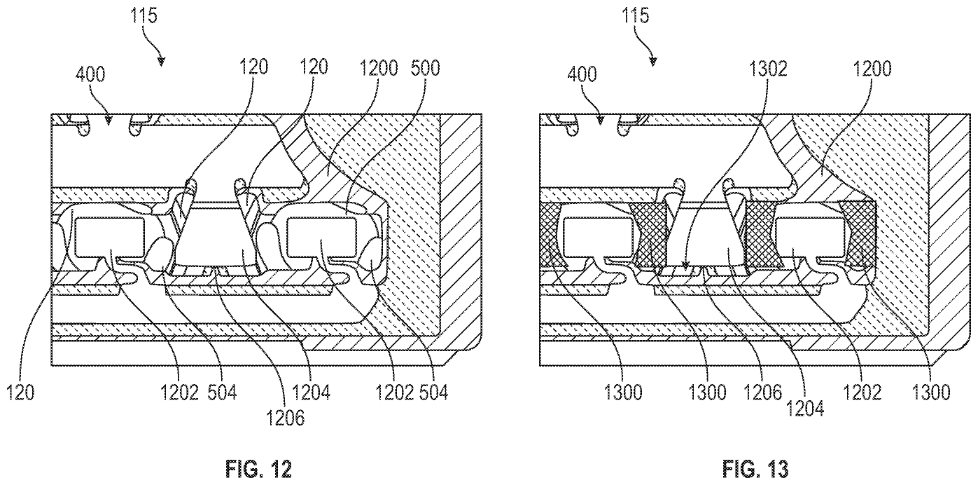

FIG. 12 illustrates a top view of a portion of the battery module 115 in which components of the CCA 400 can be seen. As shown in FIG. 12, the CCA 400 may include a frame 1200, and tabs 1202 and 1204 extending from the frame 1200. For example, the frame 1200 may be a carrier structure that is formed from an insulative material. The tabs 1202 and 1204 may be configured to electrically couple to the battery cells 120. In the example of FIG. 12, each of the tabs 1202 are electrically connected (e.g., welded) to the central portion (e.g., a positive terminal, such as terminal 218) of the terminal structure 500 of a corresponding battery cell 120. The tabs 1204 may be electrically connected (e.g., welded) to the peripheral rim 507 (e.g., a negative terminal, such as terminal 216) one, two, or more than two of the battery cells 120. In the example of FIG. 12, the battery cells 120 are provided without masks 700 or 800, and the openings 504 on the battery cells 120 may be exposed through openings in the CCA 400.

In one or more implementations, a potting material may be provided for a battery module 115 by pouring or otherwise dispensing the potting material over the CCA 400 such that the potting material flows through openings in the CCA 400 and into the spaces 1206 between the battery cells 120. However, without any masking or blocking structures, the potting material may flow into the openings 504 (e.g., and into the cavity 510 beneath the terminal structure 500).

In order to, for example, prevent a liquid (e.g., the potting material) from flowing into the openings 504 of one or more of battery cells 120, the CCA 400 may be provided with blocking structures extending from the frame 1200. For example, FIG. 13 illustrates an implementation of the CCA 400 including blocking structures 1300. As shown, the blocking structures 1300 may each extend from the frame 1200 and may each prevent a liquid from flowing into the opening 504 of one or more of the battery cells 120. As shown, the blocking structures 1300 may be configured, when the CCA is mounted to the battery module 115 and the tabs 1202 and 1204 are welded to the battery cells 120, overlay at least a part of one or more openings 504 on one or more of the battery cells 120. As shown, even with the blocking structures 1300, the CCA 400 may include remaining openings 1302 that allow a potting material to flow therethrough into the space 1206 between the battery cells 120. The blocking structures 1300 may be integral extensions of the frame 1200 itself, or may be additional structures that are attached to the frame 1200. In one or more other implementations, the blocking structures may be part of, or may be attached, to the tabs 1202.

For example, a potting material may be provided, in a liquid state, over the CCA 400 to flow into a space 1206 between the battery cells 120 (e.g., via remaining openings in the CCA 400), and to cure into a solid material in the space 1206 between the battery cells 120. Some of the potting material may remain on top of the CCA 400, including on an outer surface (visible in FIG. 13) of the blocking structures 1300. In the implementation of FIG. 13, once the potting material has been applied and cured, the battery module 115 may include the battery cells 120, the tabs 1202 and 1204 welded to the battery cells 120, and the potting material in contact with a first side (e.g., the outer surface visible in FIG. 13) of each of the plurality of blocking structures 1300, the first side opposite a second side that faces the opening 504 of one or more of the battery cells 120 (e.g., an underside of the blocking structures). In these implementations, one or more of the battery cells may include an open space (e.g., cavity 510), the open space being free of the potting material, between a current interrupt device 508 and the terminal structure 500 of those battery cells 120.

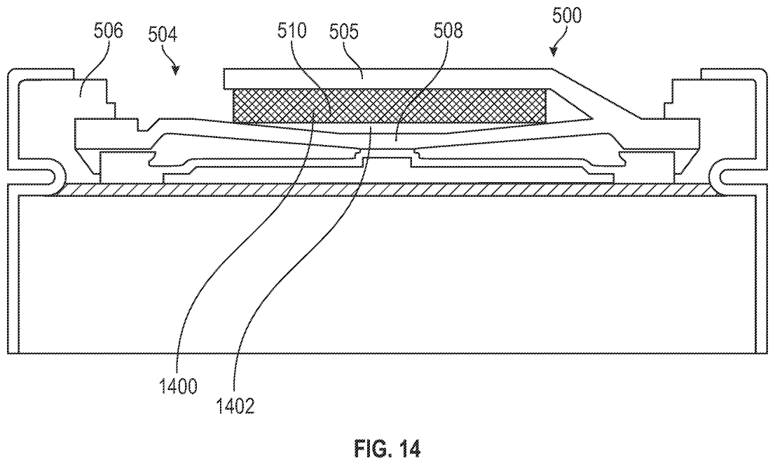

In one or more implementations, rather than (or in addition to) providing a mask (e.g., mask 700 or mask 800) on the battery cells 120 and/or providing blocking structures 1300 on the CCA 400, protection (from potting material) for the CIDs 508 of the battery cells 120 may be provided using a compliant material in the cavity 510 between the CID 508 and the terminal structure 500 of the battery cells 120. For example, FIG. 14 illustrates an example in which a compliant material 1400 has been provided (e.g., injected, such as via the opening(s) 504) into the cavity 510 between the CID 508 and the terminal structure 500, or applied during assembly of the battery cell 120). For example, the compliant material 1400 may be compressible responsive to a pressure generated by a motion of the current interrupt device 508. For example, the compliant material 1400 may be more easily compressible than the potting material that is provided for a battery module (e.g., over the CCA 400 and into the spaces between the battery cells 120). For example, in a use case in which a pressure within the battery cell 120 (e.g., within the cell housing 215) rises above a threshold pressure for displacing the CID 508 in the absence of material in the cavity 510, the compliant material 1400 may be compressible such that the resulting displacement of the CID 508 compresses the compliant material 1400, thus allowing the CID 508 to move and function as designed.

In one or more implementations, the compliant material 1400 may extend from the current interrupt device 508 to the terminal structure 500 (e.g., substantially filling the cavity 510 from top to bottom). For example, the compliant material 1400 may be disposed on an inner surface (e.g., interior surface 1100) of the terminal structure 500 and may extend (e.g., from the inner surface) toward the current interrupt device 508 within the cavity 510. The compliant material 1400 formed on the inner surface of the terminal structure 500 may extend all the way to the CID 508, which may block any potting material (which is not compressible responsive to pressure from the CID 508) from entering the cavity 510 that is substantially filled with the compliant material 1400.

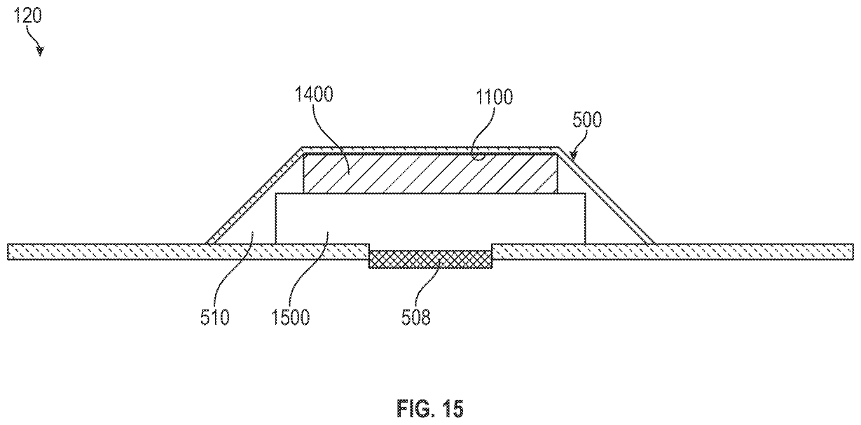

In one or more other implementations, the compliant material 1400 that extends from the interior surface 1100 toward the CID 508 may be separated by a gap 1402 from the current interrupt device 508. In these implementations, some potting material may flow into the cavity 510, such as into the gap 1402. For example, FIG. 15 illustrates a use case in which the compliant material 1400 extends from the interior surface 1100 toward the CID 508 and is separated by a gap from the current interrupt device 508, and in which a potting material 1500 has flowed into the cavity 510 (e.g., and filled the gap 1402). In the configuration of FIG. 15, although the potting material 1500 is formed on and/or over the CID 508, and is too rigid to be compressed by the CID 508, the CID 508 may be able to push or deflect the potting material 1500 into the compliant material 1400, thereby compressing the compliant material 1400 with the rigid potting material 1500 (e.g., more rigid than the compliant material 1400) and allowing the CID 508 to move to break the circuit of the battery cell 120 when pressure within the battery cell 120 exceeds a CID threshold. For example, the CID threshold may be specific to a type of battery cell 120. For example, the CID threshold for a battery cell may be specified by a manufacturer of the battery cell. Thus, in one or more implementations, the compressibility or compliance of the compliant material 1400 may be based on (e.g., less than) the CID threshold for the battery cell 120 in which the compliant material 1400 is provided.

In various implementations, the compliant material 1400 may be provided (e.g., via the openings 504, such as via injection, such as forced injection) into the cavity 510 after the cell terminal structure 500 has been attached to the battery cell 120, or the compliant material 1400 may be provided onto the interior surface 1100 of the terminal structure 500 (e.g., by attaching a compliant pad to the interior surface 1100, such as using an adhesive) prior to attachment of the terminal structure 500 to the battery cell 120 (e.g., by a manufacturer of the battery cells 120). In one or more other implementations, the compliant material 1400 may be formed on the CID 508, and may extend to the interior surface 1100 of the terminal structure 500, or may be separated from the interior surface 1100 by a gap that allows the potting material 1500 to flow over the compliant material 1400. In these other implementations, the CID 508 may directly compress the compliant material 1400 that is disposed on the CID 508 if pressure within the battery cell 120 exceeds a CID threshold.

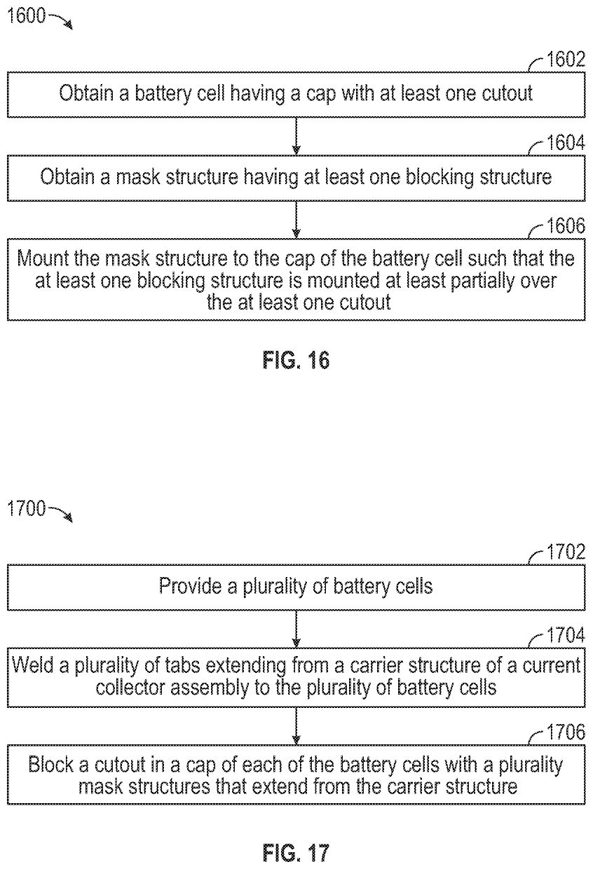

FIG. 16 illustrates a flow diagram of an example process 1600 that may be performed for providing a battery cell with a mask, in accordance with implementations of the subject technology. For explanatory purposes, the process 1600 is primarily described herein with reference to the battery cells 120 described herein. However, the process 1600 is not limited to the battery cells 120 described herein, and one or more blocks (or operations) of the process 1600 may be performed for one or more other components of other suitable cells, apparatuses, devices, or systems. Further for explanatory purposes, some of the blocks of the process 1600 are described herein as occurring in serial, or linearly. However, multiple blocks of the process 1600 may occur in parallel. In addition, the blocks of the process 1600 need not be performed in the order shown and/or one or more blocks of the process 1600 need not be performed and/or can be replaced by other operations.

As illustrated in FIG. 16, at block 1602, a battery cell (e.g., battery cell 120) having a cap (e.g., terminal structure 500) with at least one opening (e.g., an opening 504) may be obtained. Obtaining the battery cell may include manufacturing the battery cell or obtaining the battery cell from a manufacturer, in various implementations.

At block 1604, a mask (e.g., a mask 700 or a mask 800) having at least one blocking structure (e.g., blocking structure 701 or blocking structure 801) may be obtained. Obtaining the mask may include manufacturing the mask or obtaining the mask from a manufacturer, in various implementations.

At block 1606, the mask may be mounted to the cap of the battery cell such that the at least one blocking structure is mounted at least partially over the at least one opening (e.g., to prevent flow of a liquid into the opening). For example, mounting the mask to the battery cell may include adhesively attaching the mask 700 to the battery cell 120. As another example, mounting the mask to the battery cell may include attaching the mask to the battery cell using a snap fit or a press fit. As another example, mounting the mask to the battery cell may include tucking the blocking structures into respective openings 504 in the battery cell. The process 1600 may also include providing a potting material onto or into a battery subassembly containing the battery cell with the mask mounted thereon, and preventing, by the mask, the potting material from flowing into the opening(s).

FIG. 17 illustrates a flow diagram of an example process 1700 that may be performed for providing masking for battery cells using masking structures of an electrical component, in accordance with implementations of the subject technology. For explanatory purposes, the process 1700 is primarily described herein with reference to the battery cells 120 and the current collector assembly (CCA) 400 described herein. However, the process 1700 is not limited to the battery cells 120 and the current collector assembly (CCA) 400 described herein, and one or more blocks (or operations) of the process 1700 may be performed for one or more other components of other suitable apparatuses, devices, or systems. Further for explanatory purposes, some of the blocks of the process 1700 are described herein as occurring in serial, or linearly. However, multiple blocks of the process 1700 may occur in parallel. In addition, the blocks of the process 1700 need not be performed in the order shown and/or one or more blocks of the process 1700 need not be performed and/or can be replaced by other operations.

As illustrated in FIG. 17, at block 1702, one or more battery cells (e.g., battery cells 120) may be provided. Providing the battery cell(s) may include manufacturing the battery cell(s) or obtaining the battery cell(s) from a manufacturer, in various implementations.

At block 1704 one or more of tabs (e.g., tabs 1202 and/or 1204) extending from a frame (e.g., frame 1200) of a current collector assembly (e.g., CCA 400) may be welded to the one or more battery cells. For example, the tabs may be foil tabs and may include tabs (e.g., tabs 1202) that are welded to positive terminals of the battery cells, and tabs (e.g., tabs 1204) that are welded to negative terminals of the battery cells.

At block 1706, an opening (e.g., opening 504) in a cap (e.g., terminal structure 500) of each of the one or more battery cells may be blocked with one or more mask structures (e.g., blocking structures 1300) that extend from the frame. For example, blocking the openings may include blocking a potting material (e.g., potting material 1500) from flowing into a cavity (e.g., cavity 510) beneath the caps (e.g., terminal structures 500) of the battery cells using the one or more mask structures.

For example, the process 1700 may also include providing a potting material (e.g., potting material 1500), in a liquid state, onto the current collector assembly; and blocking, with the one or more mask structures, the potting material from flowing into the opening in the terminal structure of each of the battery cells. The process 1700 may also include allowing the potting material to flow through one or more openings (e.g., openings 1302) in the current collector assembly and into a space (e.g., space 1206) between the battery cells.

In one or more implementations, the process 1700 may also include allowing a first portion of the potting material to cure in the space between the battery cells and a second portion of the potting material to cure on a surface of at least some of the mask structures. Following curing of the first portion and the second portion of the potting material, a cavity (e.g., cavity 510) in each of the battery cells, the cavity for each battery cell being between the terminal structure and a current interrupt device (e.g., CID 508) of that battery cell, may be free of the potting material.

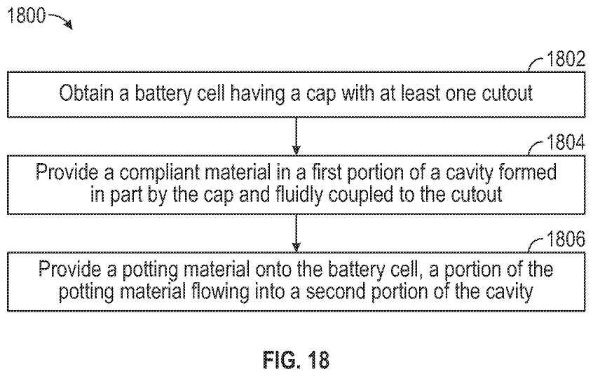

FIG. 18 illustrates a flow diagram of an example process 1800 that may be performed for providing protection for a current interrupt device of a battery cell, in accordance with implementations of the subject technology. For explanatory purposes, the process 1800 is primarily described herein with reference to the battery cells 120 described herein. However, the process 1800 is not limited to the battery cells 120 described herein, and one or more blocks (or operations) of the process 1800 may be performed for one or more other components of other suitable cells, apparatuses, devices, or systems. Further for explanatory purposes, some of the blocks of the process 1800 are described herein as occurring in serial, or linearly. However, multiple blocks of the process 1800 may occur in parallel. In addition, the blocks of the process 1800 need not be performed in the order shown and/or one or more blocks of the process 1800 need not be performed and/or can be replaced by other operations.

As illustrated in FIG. 18 at block 1802, a battery cell (e.g., battery cell 120) having a cap (e.g., terminal structure 500) with at least one opening (e.g., a 504) may be provided. Providing the battery cell may include manufacturing the battery cell or obtaining the battery cell from a manufacturer, in various implementations.

At block 1804, a compliant material (e.g., compliant material 1400) may be provided in a first portion of a cavity (e.g., cavity 510) formed in part by the cap and fluidly coupled to the opening. The compliant material may be provided into the first potion of the cavity by injecting the compliant material via the at least one opening, or the compliant material may be provided in the first portion of the cavity by forming the compliant material on a surface of the cap prior to attaching the cap to the battery cell.

At block 1806, a potting material (e.g., potting material 1500) may be provided onto the battery cell, a portion of the potting material flowing into a second portion of the cavity (e.g., as shown in FIG. 15). In one or more implementations, the process 1800 may also include compressing, via operation of a current interrupt device (e.g., CID 508) of the battery cell, the compliant material.

Aspects of the subject technology can help improve the manufacturability and/or proliferation of electric vehicles, which can positively impact the climate by reducing greenhouse gas emissions.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

1. An apparatus, comprising:
a mask configured to be mounted to an external surface of a cap of a battery cell having a current interrupt device under the cap within the battery cell, wherein the mask comprises at least one blocking structure configured to be mounted over an opening in the cap of the battery cell to prevent a liquid from flowing through the opening into a space between the cap and the current interrupt device.

2. The apparatus of claim 1, wherein the at least one blocking structure comprises a plurality of blocking structures configured to be mounted over a plurality of corresponding openings in the cap of the battery cell.

3. The apparatus of claim 2, wherein the mask further comprises a bridge structure and wherein the plurality of blocking structures extend radially from the bridge structure.

4. The apparatus of claim 3, wherein the plurality of blocking structures extend radially inward from the bridge structure, and are configured to tuck into the plurality of corresponding openings in the cap of the battery cell.

5. The apparatus of claim 3, wherein the bridge structure defines a central opening configured to be mounted over the cap of the battery cell.

6. The apparatus of claim 3, wherein mask further comprises a plurality of peripheral openings, wherein each of the peripheral openings is disposed between a pair of the plurality of blocking structures, and wherein each of the plurality of peripheral openings is configured to: allow a gas to flow therethrough between the opening in the cap of the battery cell and an environment external to the mask, and prevent the liquid from flowing therethrough.

7. The apparatus of claim 1, wherein the liquid comprises a potting material, and wherein the mask is mounted to the cap of the battery cell using a snap fit or a press fit.

8. The apparatus of claim 1, wherein the mask is formed from a flexible material.

9. The apparatus of claim 8, wherein the flexible material comprises a polymer or a rubber.

10. The apparatus of claim 9, wherein the mask and the battery cell are implemented in a vehicle.

11-20. (canceled)

21. A battery subassembly, comprising:
a battery cell comprising:
a cap having an opening; and
a current interrupt device under the cap; and
a mask mounted to an external surface of the cap, wherein the mask comprises at least one blocking structure configured to be mounted over the opening in the cap of the battery cell to prevent a liquid from flowing through the opening into a space between the cap and the current interrupt device.

22. The battery subassembly of claim 21, wherein the opening in the cap is arranged to allow a gas to flow out of the battery cell via the current interrupt device when the current interrupt device is triggered.

23. The battery subassembly of claim 21, wherein the liquid comprises a potting material, and wherein the battery subassembly further comprises the potting material in contact with an outer surface of the mask.

24. The battery subassembly of claim 21, wherein the at least one blocking structure comprises a plurality of blocking structures configured to be mounted over a plurality of corresponding openings in the cap of the battery cell.

25. The battery subassembly of claim 21, wherein the mask further comprises a bridge structure and a plurality of blocking structures that extend radially from the bridge structure, and wherein the plurality of blocking structures are tucked into the plurality of corresponding openings in the cap of the battery cell.

26. A method, comprising:
obtaining a battery cell having a cap with at least one opening and a current interrupt device under the cap;
obtaining a mask having at least one blocking structure; and
mounting the mask to an external surface of the cap of the battery cell such that the at least one blocking structure is mounted at least partially over the at least one opening to prevent a liquid from flowing through the opening into a space between the cap and the current interrupt device.

27. The method of claim 26, wherein mounting the mask comprises adhesively attaching the mask to the external surface of the cap of the battery cell.

28. The method of claim 26, wherein mounting the mask comprises attaching the mask to the battery cell using a snap fit or a press fit.

29. The method of claim 26, wherein mounting the mask comprises tucking at least a portion of the blocking structure into the at least one opening in the cap.

30. The method of claim 26, wherein the liquid comprises a potting material, the method further comprising:
providing the potting material onto the battery cell with the mask mounted thereon; and preventing, by the mask, the potting material from flowing through the opening into the space between the cap and the current interrupt device.
